(19) United States
(12) Patent Application Publication
(10) Pub. No.: US 2006/0184641 A1
(43) Pub. Date: Aug. 17, 2006

(54) System and method for implementing dynamic memorial webpages

(76) Inventor: John Moetteli, Untereggen (CH)

Correspondence Address: MOETTELI & ASSOCIATES SARL, ST. LEONHARDSTRASSE 4, ST. GALLEN, CH-9000, CH

(21) Appl. No.: 11/335,545

(22) Filed: Jan. 20, 2006

Related U.S. Application Data
(60) Provisional application No. 60/645,616, filed on Jan. 24, 2005.
(60) Provisional application No. 60/675,906, filed on Apr. 29, 2005.
(60) Provisional application No. 60/721,981, filed on Sep. 30, 2005.

(51) Int. Cl. G06F 15/16; H04L 9/32; G06K 9/00

(52) U.S. Cl. 709/217; 726/4

(57) ABSTRACT

An automated method is provided, operating on a computer and encoded on a computer-readable medium, for executing a logic flow that enables the setup, maintenance and modification of dynamic memorial pages. Such pages are customizable by the user to show an epitaph specific to the visitor and display or mask information depending on the class and/or permissions of the visitor.

### CROSS REFERENCE TO RELATED APPLICATIONS

This application is a regular application claiming priority to prior provisional applications Ser. No. 60/645,616, filed Jan. 24, 2005, Ser. No. 60/675,906, filed Apr. 29, 2005 entitled “Automated Method for Executing a Service Order Directed to a Particular Beneficiary, Initiated After a Query Requiring Minimal Response”, and Ser. No. 60/721,981, filed Sep. 30, 2005, of the same title, the contents of all of which are hereby incorporated by reference and relied upon.

### BACKGROUND OF THE INVENTION

This invention relates to server-based communications systems and methods, and more particularly, to dynamic web pages customized to particular visitors.

Epitaphs have existed since time immemorial. Carved in stone or on wood, such epitaphs are a single message meant for everyone to read with no specificity as to content. Online memorials provide an editable means to convey a message. However, the content of such messages is static and does not change until changed by the administrator of the page. This static aspect discourages revisits to the page and thus increases the likelihood that the system will lose contact with the visitor due to the fact that the visitor is not going to receive reminders to keep their email address up to date.

Human relationships with a departed individual or a memorial object vary. Immediate family may warrant an epitaph which is more personal—for friends, a message more general. However, no means exists to communicate an epitaph message which is targeted to the visitor or to the season of the year, holiday theme, or to the particular day of the year.

Still further, a distressing part of death is the fact that it is a state of inanimation. Adding animation to death can help people cope with it, offering hope.

Still further, a fear that one facing death deals with is his legacy: “will I be forgotten?” The “Golden Rule” mandates that someone who wishes to be remembered must remember those he or she wants to remember him.

A need therefore exists for a system and method which enables dynamic communications with a visitor or with respect to the time of the visit. Further, a need exists for a system and method that brings animation mimicking life to a memorial object. Still further, a need exists for a means by which someone who wishes to be remembered after death, can remember those who he wishes remember him.

### SUMMARY OF THE INVENTION

An automated method is provided, operating on a computer and encoded on a computer-readable medium, for executing a logic flow that enables the setup, maintenance and modification of dynamic memorial pages. Such pages are customizable by the user to show an epitaph specific to the visitor and display or mask information depending on the class and/or permissions of the visitor.

The method involves the following steps. In a first step, a memorial page administrator is registered. The administer may be the memorial object itself, but need not be. In a second step, the method provides administrators with means of configuring displayed information on the page, dependent on a variable, non-web-based trigger parameter (i.e. dependent on a criteria such as the season, holiday theme, time of day, day, event, or the visitor or visitor class). In a third step, the method detects the existence of the trigger parameter. In a fourth step, after detection, the method displays customized information associated with the trigger parameter to visitors to the memorial page that are permitted to view such information, such customized information optionally persisting for a validity period of time.

In a feature, invitations may be sent out to selected invitees soliciting visits to the memorial page on particular days such as special events (birthdays, anniversaries, etc).

In an embodiment, a periodic newsletter, for example, may be sent to selected invitees at predetermined times.

An object of the invention is to enable dynamic communication of a message targeted to a particular visitor or class of visitors.

Another object of the invention is to enable dynamic communication of a message depending on the time, the date or the season, such as Christmas or a birthday.

Another object of the invention is to enable a deceased user to trigger an invitation to his own memorial page without requiring a specific trigger request from the deceased user.

In an advantage, a method is provided by which someone who wishes to be remembered after death, can remember those who he wishes remember him.

### BRIEF DESCRIPTION OF THE DRAWINGS

FIG. 1A is a top level logic flow diagram of the method of the invention. FIG. 1B is a more detailed logic flow diagram of the method of the invention.

FIGS. 2A and 2B are schematic diagrams of a typical system on which the method of the invention operates.

FIG. 3 is a logic flow diagram of the registration submethod of the method of the invention of FIG. 1

FIG. 4 is a data matrix of the invention over the time domain

FIG. 5 is a data matrix of the invention of visitor classes,

FIG. 6 is a data matrix of the invention which is visitor specific.

FIG. 7 is a logic flow diagram of the activation submethod of the method of the invention.

FIG. 8 is a logic flow diagram of the service order execution submethod of the method of the invention.

FIG. 9 is a flow diagram of a invitation submethod of the invention.

FIG. 10 is an address updating submethod of the method of the invention.

### DETAILED DESCRIPTION OF THE PREFERRED EMBODIMENT(S)

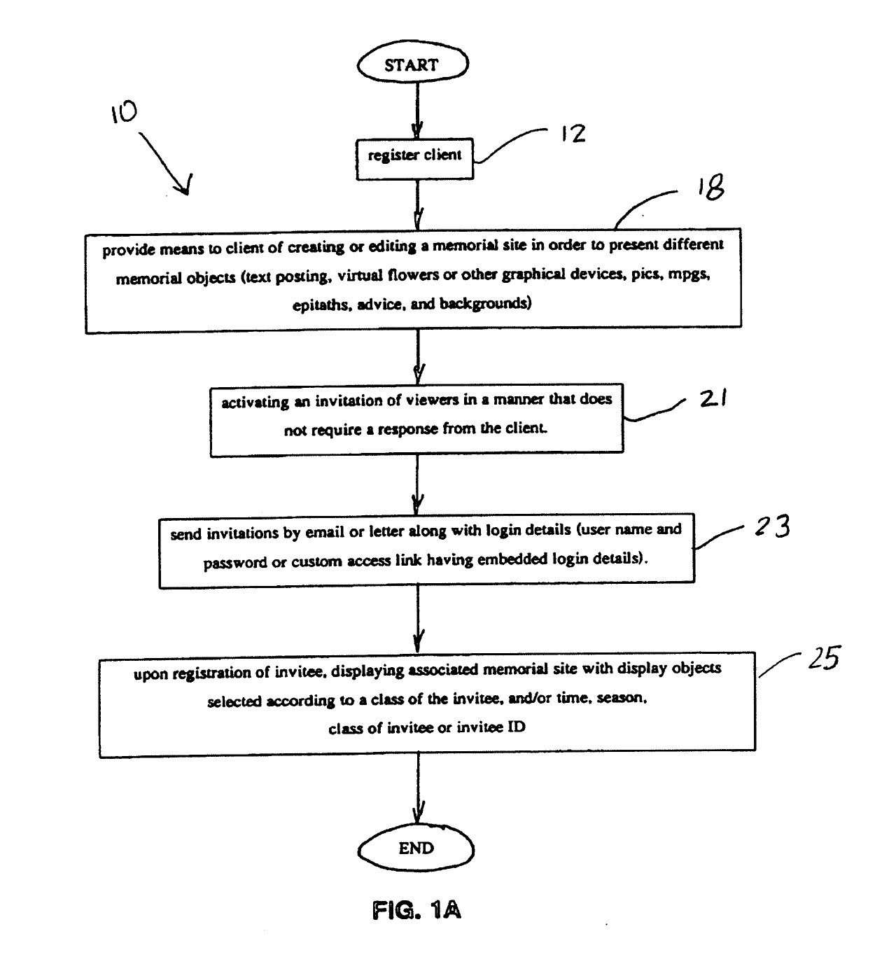

Referring now to FIG. 1A, the method 10 of the invention includes several steps. In a first step 12, the method 10 manages the registration of a memorial page administrator, be it a client 14 or a invitee/beneficiary 16. In a second step 18, the method 10 provides administrators with means of configuring information to be displayed on the memorial object webpage 20, dependent on a variable, non-web-based trigger parameter (i.e. dependent on a criteria such as the season, time of day, day, event, or the visitor or visitor class). In a third step 21, the method 10 detects the existence of the trigger parameter. In a fourth step 23, after detection, the method 10 sends invitations by email or letter along with login details (user name and password or custom access links having embedded login details). In a fifth step 25, upon registration of the invitee, the method 10 displays customized information associated with the trigger parameter to visitors to the memorial page 20 that are permitted to view such information, such customized information optionally persisting for a validity period of time.

The trigger parameter is the logging in of a particular invitee or invitee of a particular class, upon which event, the memorial page is presented to the invitee, displaying the invitee-specific memorial message and other information either specific to the class of the invitee or based on permissions assigned to the particular invitee.

In an embodiment of the method 10, the method permits the administrator to prepare to invite invitees by inputting the email addresses of invitees to the memorial object webpage, by providing fields to identify the invitee by name, class (such as relation to administrator or memorial object), birthday, etc.

In another embodiment, the method 10 permits the administrator to invite the invitees to the website to pay their respects to the memorial object, based on an activation protocol, such as the non-response of the administrator to a query from the purveyor of the system on which the website is hosted and maintained.

The activation protocol optionally is followed by an introduction and acceptance protocol which binds the invitee to contractual preconditions to the execution of the service order.

In another embodiment, the method includes an update submethod to ensure that valid contact details are maintained for invitees and users of the system.

In another embodiment, the method provides the invitee with means by which he may himself post messages which are stored in association with the memorial page and which are viewable by others or a specific visitor or visitor class, optionally, after having been filtered for objectionable language, depending permissions of others.

Referring now to FIG. 1B, in more detail, the method 10 includes the following steps. In a first step 12, the method 10 manages the registration of a user, be it a client 14 or a invitee/beneficiary 16. In an optional second step 20, an address update routine is periodically executed. In a third step 22, at an appointed time, an activation submethod is executed. In a fourth step 24, if an activation submethod 22 outputs an initiation signal, then a service order 26 is executed at the appointed time. Documents associated with service order may include registration instructions for the invitee 16, which enables the invitee to register using the registration submethod 12. The submethods 12 and 24 of the method 10 can be further broken down into substeps. In the registration submethod 12, in a first substep 12a, the user 14 is registered at a first access level, and assigned a user name and password. In a second substep 12b, the method determines if the user 14 is a client desiring after incapacitation services. If no, in a step 30, the user 14 is offered ancillary services and/or products (family tree building options, books and other media on the subject of life, death, estate planning, etc). If yes, in a third substep 12c, the registration submethod 12 is executed for a client 14 anticipating incapacitation. In an optional substep 12d, the invitee/beneficiary 16 is queried as to whether he or she would like to register and if so, he is brought to the substep 12a.

In the execution substep 24, the service order 26 is executed. Optionally, where permitted by the client 14, documents associated with the service order are appended with registration information for the invitee 16.

A first level registration substep 12a of the method 10 of the invention solicits basic information, such as name and contact details, providing access to a top level of information of interest to the subscriber, which is published on a web site of the purveyors of the method 10 of the invention.

The method 10 operates on a computer encoded on a computer-readable medium, for executing a logic flow that enables the setup, maintenance and modification of dynamic memorial pages. Such pages are customizable by the user to show an epitaph specific to the visitor and display or mask information depending on the class and/or permissions of the visitor.

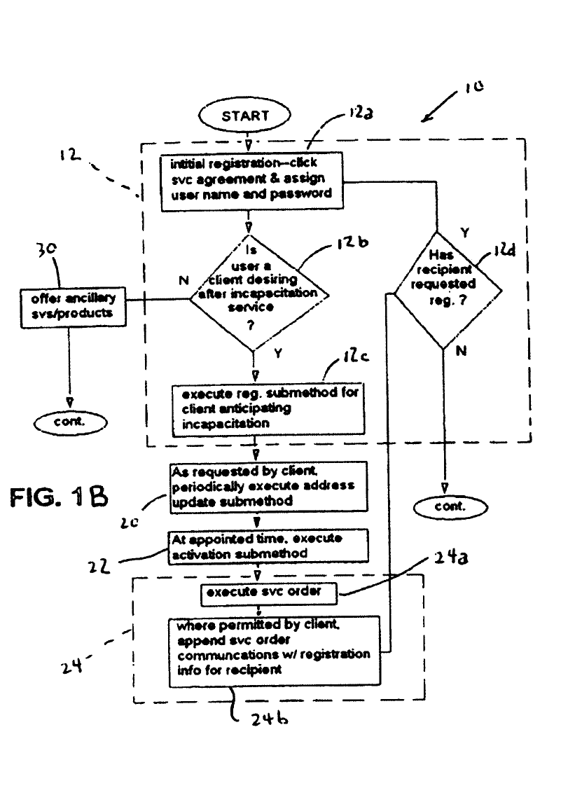

Referring now to FIG. 2A and 2B, the method 10 is implemented in a hardware and software environment, on, for example, a server apparatus 11. For the purposes of the invention, apparatus 11 may be any type of computer, or computer system, including a client computer, a server computer, a portable computer, or a handheld computer, etc. Moreover, apparatus 11 is preferably implemented using one or more networked computers, in a cluster or other distributed computing system such as the Internet. Apparatus 11 is hereinafter referred to as a “computer”.

Apparatus 11 typically includes at least one processor 13 coupled to memory 15. Processor 13 may represent one or more processors (e.g., microprocessors), and memory 15 may represent the random access memory (RAM) devices comprising the main storage of apparatus 11, as well as any supplemental levels of memory, e.g., cache memories, non-volatile or backup memories, read-only memories, etc. In addition, memory 15 may be considered to include memory storage physically located elsewhere in apparatus 11, e.g., any cache memory in a processor 13, as well as any storage capacity used as a virtual memory, e.g., as stored on a mass storage device 17 or on another computer coupled to apparatus 11 via network 18 (e.g., a client computer 21).

The apparatus 11 also typically receives inputs and outputs for communicating information externally. For interface with a user or operator, the apparatus 11 typically includes multiple input devices 23 (e.g., a keyboard, a mouse, a trackball, a joystick, a touchpad, among others) and a display 25 (e.g., a CRT monitor, an LCD display panel, and/or a speaker, among others). Otherwise, user input may be received via another computer (e.g., a computer 21) interfaced with apparatus 11 over network 18, or via a dedicated workstation interface or the like.

For additional storage, the apparatus 11 may also include one or more mass storage devices 17, e.g., a floppy or other removable disk drive, a hard disk drive, a direct access storage device (DASD), an optical drive (e.g., a CD drive, a DVD drive, etc.), and/or a tape drive, among others. Furthermore, apparatus 11 may include an interface with one or more networks 18 (e.g., a LAN, a WAN, a wireless network, and/or the Internet, among others) to permit the communication of information with other computers coupled to the network. It should be appreciated that apparatus 11 typically includes suitable analog and/or digital interfaces between processor 13 and each of components 15, 17, 18, 23 and 25 as is well known in the art.

Apparatus 11 operates under the control of an operating system 31, and executes or otherwise relies upon various computer software applications, components, programs, objects, modules, data structures, etc. (e.g., database management system 33 and database 35, among others). Moreover, various applications, components, programs, objects, modules, etc. may also execute on one or more processors in another computer coupled to apparatus 11 via a network 18, e.g., in a distributed or client-server computing environment, whereby the processing required to implement the functions of a computer program may be allocated to multiple computers over a network.

Subscription and Service Configuration Module

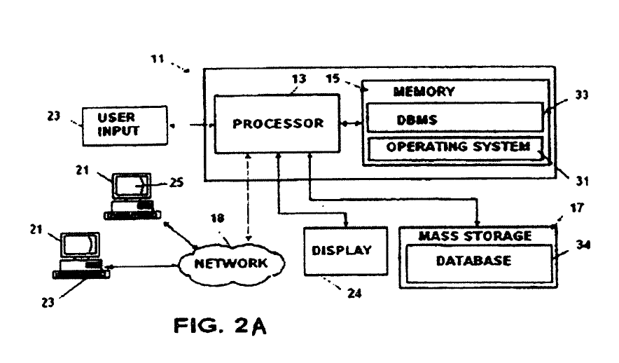

Referring now to FIG. 3, the registration submethod 12c includes a number of substeps. These steps obtain contact information from user 14 and ensure validity of supplied data. After the registration has been activated, a user and memorial object webpage are created for user 14 on the server 11.

In a first step 40, the CGI program operating on the server 11 transmits interface data to the computer 21 to cause the computer to display a menu of activation options to the user 14. Such activation options include a selection of the type of service order 26 desired, such as periodic invitations (sent by post or email and related data such as start date, periodicity, mode of activation (e.g. via phone call to the client or non-response of the client to email or letter).

In a second step 42, the submethod 12c receives and stores the service order activation options in association with the user account, preferably, in a invitee folder, for immediate execution or execution at a prescribed time.

In a third step 44, the submethod 12c causes the computer to display input fields soliciting inputs such as an introduction/purpose message (textual, audio or visual, such as via an mpeg) and the text to be displayed in time-released fashion, including, for example, text corresponding to the occasion for which the service order is to be executed, and invitee(s) therefor, whether the user desires that a contact information routine be executed from time to time, etc, and receives and stores such inputs given in association with the user, preferably organized in a invitee folder.

Message object options are populated from a relational database matrix having a column for visitor, date, season and message associated therewith. The user 14 populates a database matrix with nominated visitors to their memorial object webpage located on server 11. Each visitor is assigned a unique identification code, a class (family, parent, etc.) and private access code (password) used when accessing the memorial object webpage of user 14.

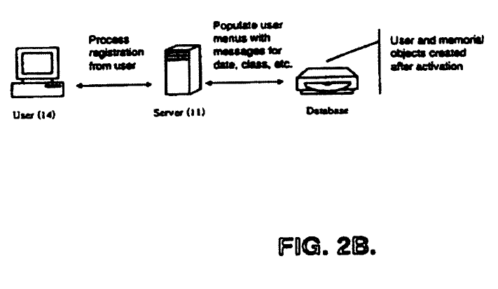

Referring now to FIG. 4, a message matrix is provided in the time domain with a column for days of the year, other columns for events and seasons/holiday themes associated with particular dates, as well as a column for code actions to perform on such dates and/or seasons. The server 11 transmits interface functions allowing user 14 to input custom messages for a given day, event or season accessible via the memorial object webpage by visitors.

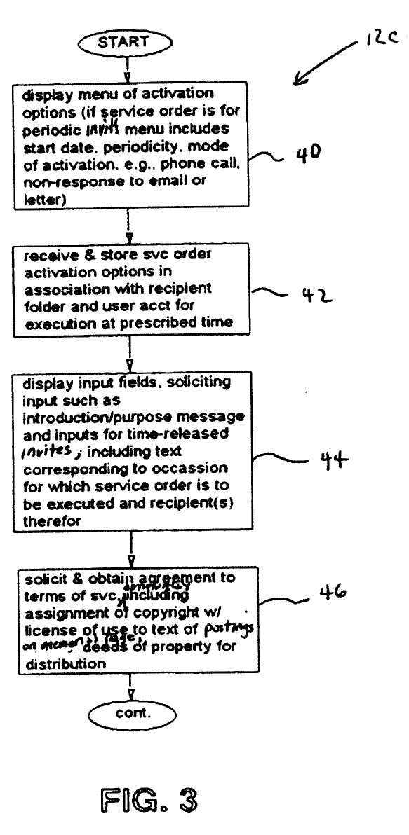

Referring now to FIG. 5, a message matrix is provided for a class of visitor, with a column for class (family, parent, friend, co-worker), and a column with codes for the associated action to be taken depending on the class of the visitor. This is particularly useful for those who visit the memorial object webpage who were not specifically invited but rather have been referred to by others. In such a case, if a visitor is not able to provide a user name and password, he must register, providing answers to a query such as inputting a memorial code and selecting from a drop-down list his class.

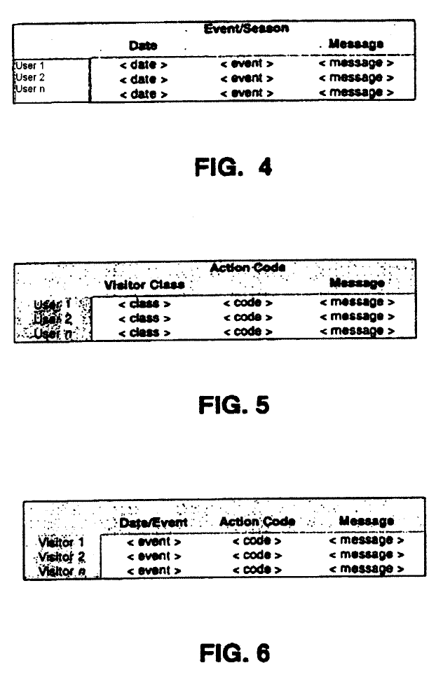

Referring now to FIG. 6, a message matrix is provided for nominated visitors to the memorial object webpage associated with user 14. In this matrix, a column including the visitor identification is linked to columns indicating the action code to be taken for this visitor on a particular date, such as the visitors birthdate, or an anniversary of the memorial object. When a visitor accesses the memorial object, the server process performs a matrix lookup to access the message and transmits interface data to display on the computer.

The data is therefore dynamically changing based on the visitor or class of visitor, or time, season, therefore encouraging invitees to remain in contact with the memorial site and thus be accessible for reminding of the need to keep his contact details up to date.

In an embodiment, the users may create a list of invitations that may be sent out to selected invitees reminders soliciting visits to the memorial page on particular days such as special events (birthdays, anniversaries, etc). Such messages may be used for instructional or even “evangelical” purposes. Using this functionality, client may pre-prepare a newsletter of information, such as, for example, advice or instructional information that is then, after the client user's passing, may be sent out to the selected invitees at predetermined times, such as bi-annually, quarterly, monthly, or any other selected periodic invitation.

In a fourth substep 46, the server 11 causes the display of a message soliciting agreement to terms of service, such as the following:

Assignment of copyright, with license to use back to assignee for use for his life only (i.e., such right to use terminates on his death)

Emphasis on importance of keeping contact details up to date

Pledge of accuracy of information

Pledge not being used to create ill-will

Permission and order to initiate service order upon non-response to a query

Limitation of Liability and indemnification

Forum in case of dispute (e.g. Switzerland)

Click to agree

Note that the copyright assignment of rights in text of the memorial website to be displayed after-incapacitation is necessary in the event that incapacitation is the death of the user, in order to prevent ownership in such copyright to pass to the heirs of the user 14 who might demand the return of such works or to terminate the service order before the invitation order is executed according to the will of the user 14.

In addition, the registrant may optionally be given the opportunity to select an email address, from a list of possible email address such as the following:

username@tilwemeetagain.com

username@saintlymail.com

username@mailfromabove.com

username@winkfromabove.com

username@heavensmail.com

username@heavenspost.com

username@thereafter.org

username@eternalportal.com

username@elportaleterno.com

username@eternalink.com

username @eternamail.com

Further, for security's sake, at least two email addresses for contact as well as a postal address may be requested.

The user is provided with tools to edit his own memorial page and to select whether or not his emails sent according to the invention described in U.S. Ser. Nos. 60/675,906, filed Apr. 29, 2005 and 60/645,616, filed Jan. 24, 2005, the contents of which are incorporated herein by reference thereto, or the responses thereto, should be published on this memorial page. Useful information may also be published on this memorial page, such as the memorial object's favorite colors, his favorite tastes, music, and allergies as well, including any genetic or hereditary traits he or she exhibited. Of course, the user may include the cause of his death and any family health history, which may be of use to his prodigy.

When the service orders are placed, the method calculates the cost of such services and provides a means of payment therefore in advance, using, for example a credit card or e-transfer.

Activation Module

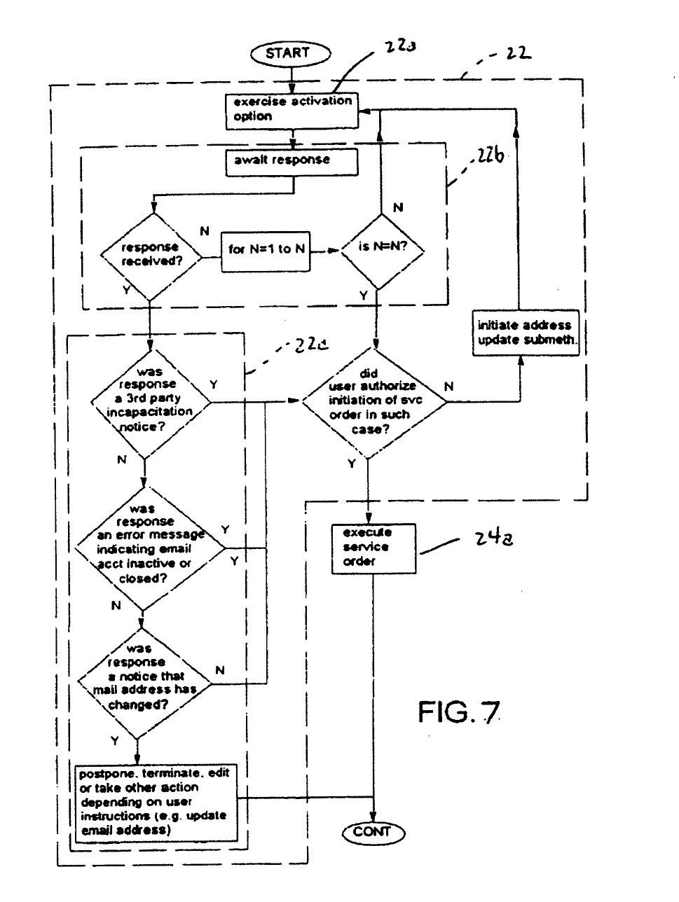

Referring now to FIG. 7, a first activation submethod 22 of the invention, wherein activation is initiated upon non-response of the user to a query, includes several substeps. In a first substep 22a, the activation option selected by the client is exercised. In a second substep 22b, the method 10 awaits a response, and, if after a pre-determined period of time, no response is received, then the method asks again up to N times, according to the instructions received from the client. In a third substep 22c, response is analyzed, to determine whether the response was a third party incapacitation notice, an error message indicating that email account is inactive or closed, in which case, if so authorized by the client, the service order is activated. Otherwise, in a fourth substep 22d, appropriate action is taken, such as postponing, terminating, modifying service order, or correcting mail address data, as instructed by the client.

Referring again to the activation options mentioned in substep 22a, this may include a telephone call and query, non-response to a letter after a predetermined amount of time, non-response to an email after a pre-determined amount of time. A telephone query may simply be asking whether the client is home and listening for the answer, which may include a requirement that a code word be given in order to authenticate the user 14, should the person responding claim to the user. Activation may also simply begin at a specified time in the future, long enough into the future that activitation is assured after the death or celebrated event of the memorial object or client.

Introduction and Acceptance Module

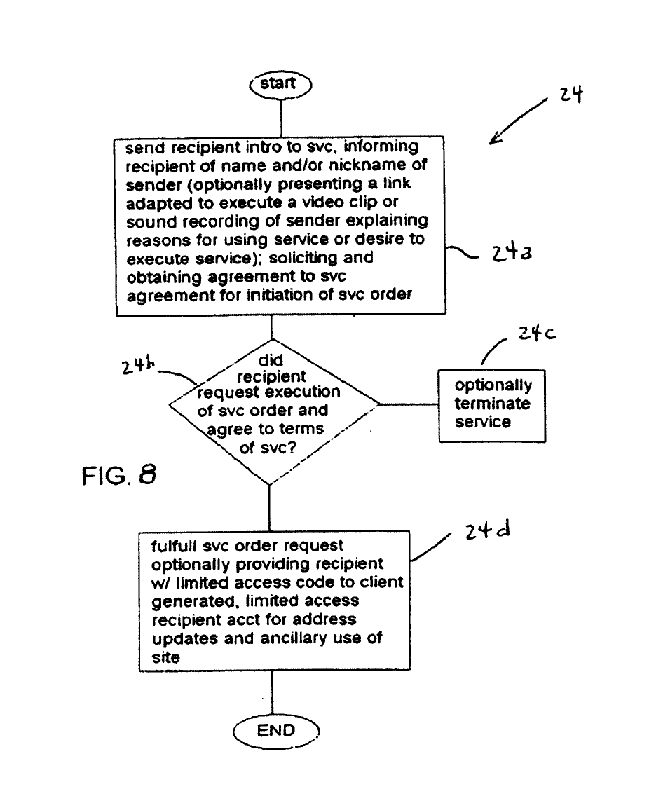

Referring now to FIG. 8, the service order execution submethod 24 includes several substeps. In a first optional substep 24a, where the client is a person who has died and who wished that certain persons be invited to visit his memorial page, the recipient/invitee is sent an introduction to service and is informed of the concept of the method of the invention, in order to minimize the emotional consequences that might be associated with receiving an unexpected communication from a recently deceased loved one. Where the method of informing is an email having, for example, html or xml links, the invitee 16 is provided with a hypertext link or an icon which is activated by a mouse click to show a video and/or audio clip (in mpeg format, for example) of the client 14, explaining his intentions in using the method of the invention. In a logic gate 24b, the informational email solicits the invitee 16's agreement to terms of service for initiating the service order and, in the event the client 14 wished to communicate valuable information, such as the location of a key to a safety deposit box, then the introduction would include an authentication step in which the invitee must respond to a query which, if answered corrected, would satisfy the client 14 of the recipient/invitee's 16's identity. Such an authentication step is initialized via the input by the client of keywords in association with a question he asks in a communication with the invitee, as described in more detail below.

Otherwise, in a third substep 24c, optionally, the recipient 16 is given the option of terminating the service. One reason for termination of the service could be the fact that the client is not dead and the activation of the service order by non-response failed in its assumption. If the recipient 16 did request execution of the service order, then in substep 24d, the service order request is fulfilled, optionally providing recipient 16 with a limited access user name and password to log on and modify address information stored in the invitee folder created by the client, and presents the invitee 16 with ancillary products and services that might be of interest. For example, an ASP version of family tree creation software, such as that available from Pearl Street Software, in Boulder, Colo., may be offered to the invitee 16 to help them build their family tree. Family Tree Legends™ version 4.0 provides users with tools to communicate with other users instantly over a secure, encrypted network where users can share text messages, scrapbook images, and file data. Such software permits users to find, review, and integrate matching data in the files of other users, to back up data files, and to publish the family tree in a home page with a minimal learning curve. In addition to the services offered by the method 10 of the invention, the invitee 16 may purchase gifts, flowers, cards, and downloadable software products, as well as books and religious icons may be offered.

Memorial Management Module

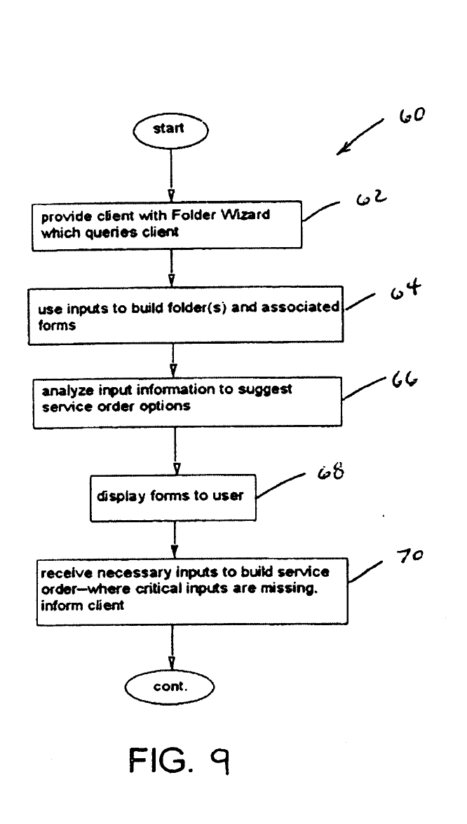

Referring now to FIG. 9, a memorial management submethod 60, facilitates the editing, storage, and association of display objects with classes and specific visitors. In a first substep 62, the submethod 60 provides the client 14 with a Folder Wizard which walks the user through the creation of invitee folders and related forms, by which questions are asked of the client 14 (such as “do you have any surviving children?”, “What are their names, and ages?” “Do you have a surviving spouse?” “What is his/her name or age?”) and uses this information to create corresponding folders for each potential invitee, soliciting further information about each invitee such as their names, birthdates, wedding anniversaries, addresses, and relationships to the client, as well as service order information (invitation date, event name, periodicity, end date). In a second substep 64, such inputs being used to generate an appropriate, pre-configured invitee folder for convenient storage of invitee contact and service order data, and for automatically associating links to features, themes, or services which are likely to be of interest according to the input relationship (if husband and wife relationship, the CGI program transmits links which facilitate the selection of a love theme and can suggest special backgrounds which correspond to an anniversary of marriage, on a wedding date, on a birthdate of a child, on mothers day, for example). Note that, in a preferred embodiment, the end date is suggested after input of the birthdate, by the system comparing the birthdate to today's date, accessing a look-up table of life expectancies, calculating how many more years the invitee is likely to live and thus, outputting a suggested end date, as well as populating a default field which, unless changed, will generate a suggested number of input fields for website messages corresponding to the life expectancy of the invitee. Further, optionally, each input field includes a Hint generator, which periodically displays hints associated with the event on which the invitation is to be sent, to help the client in editing and selecting content for the memorial site. For example, if the event is a birthday for a 20 year old, then a set of hints which might be cycled through a hint or banner window might be as follows:

? On this day in History/Examples of world events when you were 20, include:
President Smith was elected President of the US
XYZ was the hit song playing on the charts

? What did you do on your 20^{th} birthday?

? At this age, a <female/male, as the case may be>]is struggling with:
X
Y
Z

? What advice would you have for someone celebrating their 20^{th} birthday?

? Would you like us to suggest a poem for your loved one?

In a third substep 66, the submethod 60 analyzes the input information to intelligently suggest, and to allow the client 14 to choose from a selection of service order options, memorial site message themes and content. In a fourth substep 68, the submethod 60 presents a date-specific form created for example by a form wizard created using “INFOPATH”™ on a “SHAREPOINT SERVER”™ (the input fields being generated depending on the client's answers to queries) in which the user 14 can input service order information such as event name, invitation date, message text, text framing. For example, where the periodicity selected is annual, and the start date is 2006, end date is 2056, then the Form Wizard creates fifty text input fields which can be customized by the user with specific text and background motifs, and attachment of mpegs, etc. In a fifth substep 70, taking the client's inputs, the submethod 60 compiles the service order 26 and prepares it for execution.

In an optional service, invitees are able to post responses to the invitation email. For example, a central mail server, similar to “OUTLOOK”™, scans any posted messages using rules which look for the presence of such keywords in the response. Where such keywords exist, then the posting initiates the sending of a response email, such as a thank you email, or even a code or mailing of a deposit box key by employees of the purveyors of the system of the invention. For example, a pre-programmed message may be displayed on a field of the website directed to the visitor which reads “You remember your first puppy's name? You know, the runt that couldn't sleep anywhere but next to your bed?”. The invitee then responds in a response field on the website and includes the name of the puppy. A rule set on a, for example, Microsoft Outlook Exchange server, scans the posting and if the keyword is detected, executes a macro or rule which automatically sends a response, which could include, for example, a bank account number and access code, or instructions on where the client may have hidden or buried a gift. Of course, such messages should not to be published. Therefore, where the client has selected an option by which all messages and response postings are published on a memorial page associated with the client, such postings having the trigger question and the answer are filtered out of those which are published.

When the invitation submethod 60 is integrated in a color printer or printing system (not shown), then, on the appointed day, the method 10 causes the system to automatically print out a card or letter with the client edited text corresponding to that particular event (birthday, for example), and a corresponding envelop addressed with the invitee address stored in the database. A convenient format for such card is a tri-fold (or a bi-fold with a third overlapping minor panel) wherein, on an outside portion of which, the invitee and return addresses can be printed, followed by printing of the associated message on the inside. Then such card can be closed via a seal or even the stamp to be used for invitation itself, and delivered by regular post. Of course, a postage meter machine can be integrated in an automated process so as to automatically posted and then placed in a post office bag for invitation in bulk by the postal service.

In another feature, the wizard offers users the opportunity to select from a variety of canned service orders, optionally suggesting the canned service order which match the client's profile (determined from a review of the client or from an automatic profile analysis of the client's profile inputs), thereby enabling users who are weak, cannot write well, or are near death and therefore have no time to fully customize their profile to prepare a fully populated service order quickly and conveniently. An evangelical message presenting, for example, the four spiritual laws, is easily integrated into such a canned service order. Optionally, one of the inputs is the user's estimated time of death so that the canned service orders can be customized in a manner enabling communication of the approximate time of death (e.g., enabling communication of a message such as “I've been gone now for X years”, or pre-edited to send out evangelical messages).

A help feature suggests the theme based on characteristics such as the relation of the invitee 16 to the client 14, or the event type of relationship. For example, if the event is a birthday, the help feature will suggest that the client 14 describe in text for posting on the memorial site what happened to him on his same birthday, or to add advice to someone of the age of the invitee at the time of reception or information about a related family event. In another example, where the relationship is parental, then the help feature, next to the end date information, will suggest that the client 14 create enough invitations to bridge the gap between the client's death and the expected date of death of the invitee 16. The purpose of the help feature is to facilitate the population of the data fields required to fulfil the service order 26.

Update Module

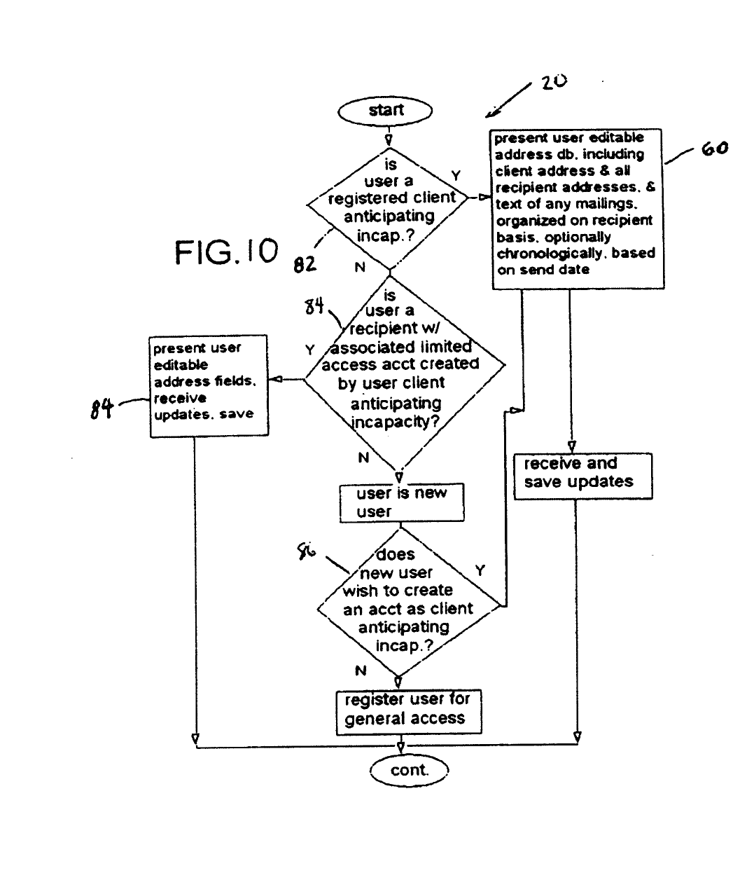

Referring now to FIG. 10, an address update submethod 20 is provided which helps ensure that the service order is timely executed and that it may continue to be executed throughout the order life. Further, such submethod 20 provides a means by which new clients may be generated or other products and services sold.

In a first substep 80, a logical “or” gate 82 determines if the user is a registered client 14 anticipating incapacity. If yes, the user is sent to submethod 60. If no, a second or gate 84 determines whether the user is a invitee with an associated limited access account created by the user client 14 anticipating incapacitation. If the user is a invitee 16 with associated limited access account created by the user 14, then, in substep 84, the invitee is presented with user editable address and contact information, whereby the user may review, edit and update the information and save such changes.

If no, the user is a new user, and, in substep 86, the submethod 20 asks whether the user wishes to create an account as a client anticipating incapacity. If no, the user is prompted to generally register for limited, general access as sent to substep 30 of method 10.

In an example of use, a client 14 has been told by his physician that he is not likely to live more than one year. That client 14 logs on and registers on the system. The method 10 of the system asks for the names, contact information and ages of his dearest friends and relatives. This information is then used to automatically generate folders and as inputs to a form tool which associates similar services to the user client and invitee relationship, and to generate a number of input fields associated with the expected life span of the invitee, and then makes recommendations to the client user. The client user is presented with terms of service which he accepts and goes through the work flows described herein.

Further, when a invitee receives his introduction email, he also receives a password and user name, allowing him to logon to the server. There, he can view those memorials he has a right to view, but now the client has set things up so that the “epitaph” is customized to that particular invitee, and potentially, to the day, season, age of the invitee . . . A standard time dependent message might be:

Epitaph: “It's July 1st, 1943—my birthday. I would be ______ years old if still alive today. My ______ (daughter/son) is now ______ years old. To all who visit me on this day, I wish to say ______.”

A visitor dependent message might be:

Epitaph:

“John Doe, who only wanted the best for his daughter, Amy, on whom he wishes only the best life can offer.”

Message to visitor:

Amy, I love you and hope that you still think about me from time to time. You're now 73 years old. Use the time you have left wisely. Hebrews 12:1.

The user is simply provided with input fields when a invitee folder is configured. In addition, input fields are provided for epitaphs that are time dependent, such as as follows:

Generic Epitaph 2010, enter text:[ ]

Generic Epitaph 2020, enter text:[ ]

Invitee Specific Epitaphs:

Invitee: ______, Year or validity dates (select from calendar or enter beginning and end dates): ______ Text: ______

Optionally, the client is provided with the ability create a “private (for selected recepients)” or “public” memorial. For example, a public memorial might include general info of potential interest to any visitor, such as favorite colors, foods, words of wisdom, favorite jokes, and wishes for posterity. The private memorial would include topics such as regrets, secrets revealed (password protected), most embarrassing moments, etc. However, a half-public option may also be provided (where only certain health information is published and others available only to specific visitors).

In another embodiment, the memorial site provides visitors with the option of purchasing a “virtual flower”, a digital picture of a flower, optionally animated. When a flower is purchased, the purchaser is recognized via a listing of donors on the memorial site.

Optionally, site users are provided with the ability to create a memorial page to honor some one else.

In another option, each memorial page can be purchased or rented on a time basis (i.e., for a contractual period of time), whose active life can be extended by others purchasing more time. If no one visits a particular memorial page in a certain period of time, then it's posting life is limited to say 5 years. If someone visits, then, with each visit, the life of the site is extended by x minutes, hours or days. On the page, a counter may indicate the number of visits and indicate as well, the current expiration date for the site. Visitors can purchase more time and watch the expiration date change to the extended date.

This, together with the fact that the site is dynamic, better ensuring future re-visits of the invitees. More visits increases the likelihood that the invited will keep his contact details updated so as not to lose contact in the future.

In an alternate embodiment, the invitation may be initiated at a date long enough in the future to best guarantee that the client is dead and that the invitation will now be timely. In another means of helping to ensure that the contact details are still valid, the client is provided with the option of offering a pre-paid service to the invitee, such as pre-paid email address, emailing and storage for, say, ten years. Via the service agreement which the invitee must accept for this service, the invitee agrees to allow the service provider to communicate with the purveyors of the method of the invention, to update the mailing and emailing address of invitee. In this way, the purveyors are better ensured of having the correct address at the time of execution of the service order.

In another alternate embodiment, the invitation may be initiated at death by an undertaker as part of a death package that the client may purchase from the undertaker. In this alternate embodiment, the user is given a logon username and password. The user then logs on and answers the queries as described above, allowing the system to create appropriate folders and text fields so as to allow the user to complete the text and complete the service order. Thus, in this embodiment, the initiation of the service order upon non-response to a query is not required. The service order is initiated by the client's loved ones by their informing the undertaker to execute the service order.

In an alternate embodiment, the system outputs and prints all cards in advance and mails them to the client for personal signature. Such cards are then returned by the client and stored for invitation at the appropriate time.

In an alternate embodiment, the client chooses the typestyle for a printable stylized signature from a database of signature styles and the cards are printed with this signature.

In another alternate embodiment, the client chooses a listing of signature styles and gives permission to the purveyors of the system, in the service order agreement, to sign on behalf of the client, trying to follow the style of the pre-selected signature style.

In another embodiment, in the subscription step, the client is queried as to whether or not he would like emails he sends, or his variable messages and any postings thereto, published on his memorial page. In order to minimize the inadvertent publication of writings considered too personal for publication, the invitee is warned, in a header or a footer of the invitation email of the possibility of publication. Thus if the invitee responds, he implies his permission for publication of such response. The invitees may also optionally be given the ability to log on to the memorial site and delete any emails from them that were inadvertently published.

In a feature of the invention, an activation submethod actives the method upon non-response of the client to a query or series of queries.

Such a system is advantageously used by a client anticipating incapacitation, namely, those who are aging and anticipate serious nursing care, death, or inaccessibility to conventional communications mediums to pre-order a service order to invite a prescribed beneficiary/invitee to his memorial page.

In another advantage, a method is provided to help deal with an age-old, as yet, unsolved problem, of providing peace of mind to those facing the inevitable and stressful event of death.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. An automated method operating on a computer and encoded on a computer-readable medium, the method following a logic flow that enables the setup, maintenance and modification of dynamic memorial pages, the logic flow involving the steps of:
(a) registering a memorial page administrator;
(b) providing administrators with means of configuring displayed information on the page, dependent on a variable, non-webbased trigger parameter;
(c) detecting the existence of the trigger parameter; and
(d) displaying the customized information associated with the trigger parameter to visitors to the memorial page that are permitted to view such information, such customized information optionally persisting for a validity period of time.

2. The method of claim 1, wherein in step (b) above, the means of configuring includes configuration of memorial pages by the administrators directed to the memory of a memorial object, including saving of email address of invitees to the memorial page, saving of memorial messages associated with particular invitees, and storing characteristic information such as the class of the invitee to the memorial object, such invitees being assigned a user name and password and, optionally, a permission set, inviting such invitees via conventional means, preferably by email

3. The method of claim 2, wherein the trigger parameter is the logging in of a particular invitee, upon which event, the memorial page is presented to the invitee, displaying the invitee-specific memorial message and other information either specific to the class of the invitee or based on permissions assigned to the particular invitee.

4. The method of claim 3, wherein the invitee is provided with means by which he may himself leave messages which are stored in association with the memorial page and which are viewable by others, optionally, after having been filtered for objectionable language, depending permissions of others.

5. The method of claim 4, wherein the leaving of a new message triggers the sending of a notice email directed to other invitees, preferably exclusively invitees of the same class.

6. The method of claim 2, wherein the class of invitee corresponds to one specific, individual, known beneficiary.

7. The method of claim 2, wherein the class of invitee corresponds to a contact of a political branch of government.

8. A method of inviting viewers to a memorial site, the method comprising the steop of:
a. registering a client;
b. providing a means to the client of creating or editing a memorial site in order to present different memorial objects (text posting, virtual flowers or other graphical devices, pics, mpgs, epitaths, advice, and backgrounds);
c. activating an invitation of viewers in a manner that does not require a response from the client;
d. send invitations by email or letter along with login details (user name and password or custom access link having embedded login details); and
e. upon registration of the invitee, including adhering invitee to terms of use, displaying associated memorial site with display objects selected according to a class of the invitee, and/or time, season, class of invitee or invitee ID.

9. The method of claim 8, the method optionally providing means for the invitee to post display objects selected from a group of display objects consisting of virtual flowers, text postings, vi.
